(19) United States
(12) Patent Application Publication
(10) Pub. No.: US 2015/0177923 A1
(43) Pub. Date: Jun. 25, 2015

(54) EVENT NETWORKING METHOD

(71) Applicants: Randy Philip, Alexandria, VA (US); Thomas Typinski, Arlington, VA (US)

(72) Inventors: Randy Philip, Alexandria, VA (US); Thomas Typinski, Arlington, VA (US)

(21) Appl. No.: 14/409,335

(22) PCT Filed: Jun. 24, 2013
(86) PCT No.: PCT/US13/47345

§ 371 Date: Dec. 18, 2014

Related U.S. Application Data
(60) Provisional application No. 61/663,851, filed on Jun. 25, 2012.

(51) Int. Cl. G06F 3/0482; H04L 29/06; G06F 17/30

(52) U.S. Cl. CPC G06F 3/0482; G06F 17/30861; H04L 65/403

(57) ABSTRACT

A method for social networking focusing on events includes displaying a dashboard with input prompts for at least one event, at least one of receiving input selecting access to a first menu to establish a new event, displaying a menu for establishing a new event, receiving input regarding the location of the new event, receiving input regarding a time and date of the new event, and receiving input to publish the new event. The method also facilitates interaction with users to find and select established events.

### CROSS-REFERENCE TO RELATED APPLICATION(S)

This International Patent Application relies for priority on U.S. Provisional Patent Application Ser. No. 61/663,851, filed on Jun. 25, 2012, the entire contents of which are incorporated herein by reference.

### FIELD OF THE INVENTION

The present invention concerns a method, implemented in software, that facilitates the creation and participation in social activities, otherwise referred to as “events.” More specifically, the present invention provides a method, implemented in software, that compliments a user's social network by helping the user to create events involving at least one other participant, join events created by another participant, and/or coordinate plural events involving at least one other participant.

### DESCRIPTION OF THE RELATED ART

While not limiting of the present invention, the prior art to the present invention encompasses different software programs that have become known as “mobile apps.” Mobile apps are programs that are typically executed on a mobile platform (such as a mobile phone, tablet device, or other portable electronic device).

There are a number of social networking apps that are known in the art. These social networking apps permit persons to contact other persons who also use the same app. In many cases, social networking apps permit persons to create profiles for themselves and post those profiles for others to examine. In addition, those social networking apps permit users to search for other persons by searching for information that others post in their respective profiles.

In addition, there are social networking apps that rely on Global Positioning System (“GPS”) data so that participating users may find one another based on their respective, geographic locations.

There remains, however, no social networking app that permits a user to network with multiple individuals at the same time by establishing or joining a particular social event.

A desire has developed for event-based social networking tools.

### SUMMARY OF THE INVENTION

The present invention addresses one or more deficiencies associated with social networking apps known in the prior art.

It is, therefore, one aspect of the present invention to provide a method for social networking focusing on events. The method is executable via a device that includes a processor and a display. The method includes, via the device, receiving input selecting access to a first interface to search for an established event from a plurality of established events and receiving at least one input parameter for searching for the established event. The method further includes searching through the plurality of established events based on the at least one input parameter and, via the display, displaying established events results including those established events satisfying the at least one search parameter. In addition, the method includes, via the device, receiving input to join at least one event from the established events results, creating a joined event.

In one contemplated embodiment, it the method may update a list of participants for the joined event to create an updated list of participants.

In another contemplated embodiment, the updated list of participants for the joined event may be provided to the user via the display.

It is contemplated that the method will include via the device, receiving input to request return to the first interface. This permits the user to begin a new search, for example.

In the method contemplated for the present invention, the input parameters may include variables, such as, a genre of the established event, a name of a venue for the established event, a date for the established event, a time for the established event, and a type of the established event indicating a number of persons involved therein.

The method also may include, before the step of receiving input parameters for searching for established events, receiving an input selection based on a geographic map interface via the device.

Alternatively, the method may include, before the step of receiving input parameters for searching for established events, receiving an input selection based on an event list interface. This input selection is contemplated to be received through the device.

Also, before the step of receiving input parameters for searching for established events, it is contemplated that the device may receive an input selection based on a person interface.

The method of the present invention also may include, via the device, receiving input selecting access to a second interface to establish a new event. If so, it is contemplated that the device may receive input regarding the genre of the new event, which may be selected from a list of genres for the new event, regarding a name of a venue for the new event, or regarding a time and date of the new event.

Via the device, it is contemplated that the method will receive input to publish the new event as the established event.

It is also contemplated that the method may receive input regarding the number of participants for the new event. If so, the method is contemplated to update a list of participants for an established event and, via the display, display the updated list of participants for the established event.

After creating and publishing the new event, the method includes receiving input to request return to at least one of the first interface and the second interface.

The device may include a touch-sensitive display interface. Moreover, the device may be configured to display an alphanumeric keyboard.

The device may be a smartphone, tablet, or mobile computer.

Still further features of the present invention should be appreciated from the drawings appended hereto and from the discussion herein.

### BRIEF DESCRIPTION OF THE DRAWINGS

The present invention will now be described in connection with the drawings appended hereto, in which:

FIG. 1 is a graphical illustration of a first portion of the method of the present invention;

FIG. 2 is a graphical illustration of a second portion of the method of the present invention;

FIG. 3 is a graphical illustration of a third portion of the method of the present invention;

FIG. 4 is a graphical illustration of a fourth portion of the method of the present invention;

FIG. 5 is a graphical presentation of one embodiment of a first graphical user interface consistent with the method of the present invention;

FIG. 6 is a graphical presentation of one embodiment of a second graphical user interface consistent with the method of the present invention;

FIG. 7 is a graphical presentation of one embodiment of a third graphical user interface consistent with the method of the present invention;

FIG. 8 is a graphical representation of one embodiment of a fourth graphical user interface consistent with the method of the present invention;

FIG. 9 is a graphical presentation of one embodiment of a fifth graphical user interface consistent with the method of the present invention;

FIG. 10 is a graphical presentation of one embodiment of a sixth graphical user interface consistent with the method of the present invention;

FIG. 11 is a graphical presentation of one embodiment of a seventh graphical user interface consistent with the method of the present invention;

FIG. 12 is a graphical presentation of one embodiment of a eighth graphical user interface consistent with the method of the present invention;

FIG. 13 is a graphical presentation of one embodiment of an ninth graphical user interface consistent with the method of the present invention;

FIG. 14 is a graphical presentation of one embodiment of a tenth graphical user interface consistent with the method of the present invention; and

FIG. 15 is a graphical overview of one system contemplated as a part of the present invention.

### DETAILED DESCRIPTION OF EMBODIMENT(S) OF THE INVENTION

The present invention will now be described in connection with one or more embodiments. Discussion of any one particular embodiment is intended to be illustrative of the breadth and scope of the invention. In other words, while attention is focused on specific embodiments, those embodiments are not intended to be limiting of the scope of the present invention. To the contrary, after appreciating the discussion and drawings presented herein, those skilled in the art will readily appreciate one or more variations and equivalents of the embodiments described and illustrated. Those variations and equivalents are intended to be encompassed by the present invention as though they were described herein.

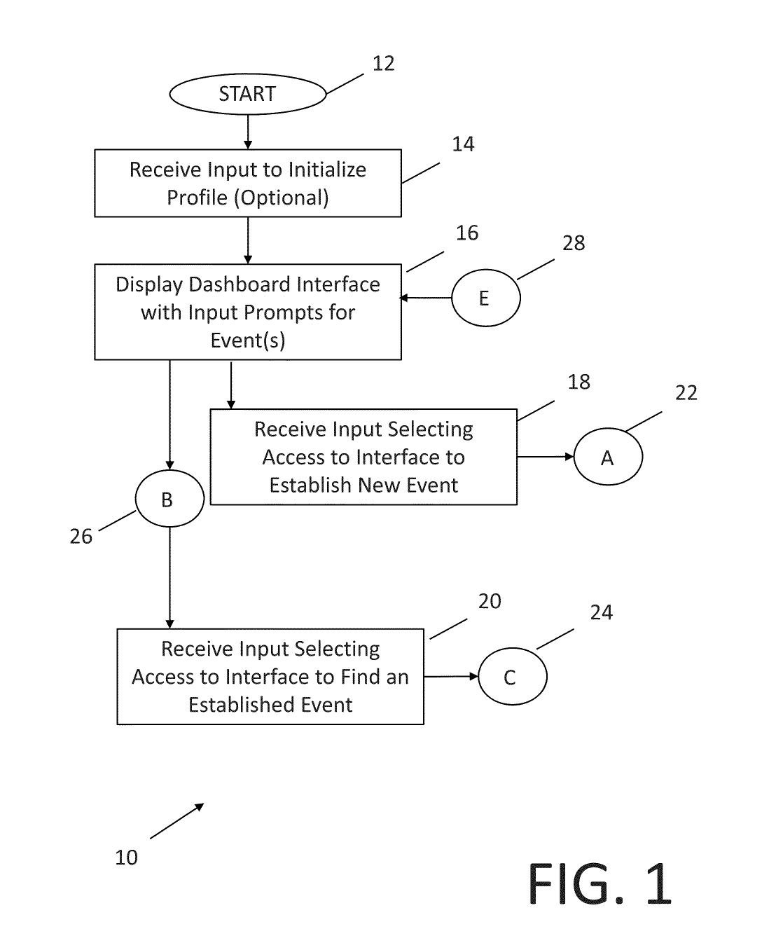

FIG. 1 is a graphical illustration of a flow chart that illustrates a first part of the social networking method 10 of the present invention.

The method 10 starts at step 12. The method 10 then proceeds to step 14, where the user is prompted to input data to initialize a profile for the user. At step 14, the method 10 receives input that permits the method 10 to initialize the user's profile.

At step 14, the user may input data such as a user name pand a password, among other information. For example, the user may indicate a preference to meet men, women, or both. The user also may enter information about oneself in an input box associated with the initial profile. Step 14 also may be accessed by the user to update his or her profile over time.

As should be apparent, aspects of step 14 may be optional. While it is anticipated that the user will be required to provide a user name and password for purposes of repeatedly accessing the method 10 of the present invention, other personal information is optionally required for operation of the present invention. Moreover, in one embodiment of the present invention, it is contemplated that a user may not be required to enter any information, but may be permitted to peruse the functionality of the method 10 as a guest.

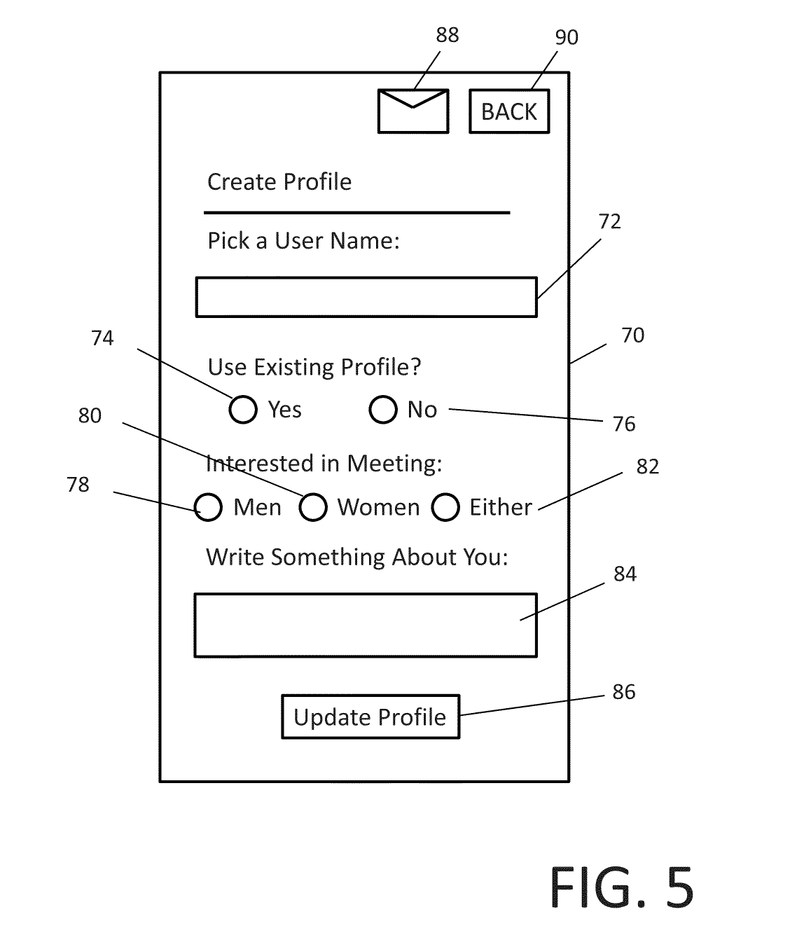

FIG. 5 provides one contemplated graphical user interface (“GUI”) that may be presented to the user at step 14. The GUI illustrated in FIG. 5 is labeled 70 and is called the initialization interface 70, for reference. Various inputs that may be provided by the user are indicated, as discussed above, to initialize the user's profile for use by the method 10.

As indicated in FIG. 5, the initialization screen 70 includes a user name field 72 into which a user may enter a preferred user name. As should be apparent, the user name may be the user's actual name or an identifier that is entirely fanciful. Separately, the initialization interface 70 is contemplated to include a profile load option, which permits the user to rely on a previously-established profile. In the illustrated example, the profile load option permits importation of a user profile, such as a profile from Facebook (having a corporate address at 1601 Willow Road, Menlo Park, Calif. 94205, USA). While a Facebook profile is indicated as being importable, any other suitable profile may be imported without departing from the scope of the present invention. If a user wishes to rely on an existing profile, the user will select the “yes” icon 74. If so, the user will be prompted for relevant information to import the existing profile. If the user selects the “no” icon 76, the user will be asked to provide additional information, such as the information identified in the paragraphs that follow. As should be apparent, the method 10 of the present invention may rely on a hybrid of information from a pre-existing profile and supplemental information provided by the user, as required or as desired.

The initialization interface 70 also includes three gender preference options 78, 80, 82, which permits persons to indicate a preference to the gender of the person(s) the user wishes to meet, i.e., male (via the “male” icon 78), female (via the “female” icon 80), or both (via the “either” icon 82).

In addition, the initialization interface 70 includes a comment block 84, which permits the user to enter a summary description of himself or herself. The comment block 84 may be limited to a predetermined number of characters or may be unlimited, as required or as desired.

As should be apparent, the initialization interface 70 may include additional options for a user to present a suitable profile to other users. The embodiment of the initialization interface 70, therefore, is intended to be merely representative of the types of information that may be entered by a user to access the method 10 of the present invention.

After the user has provided the requested information, the user may press the “update profile” icon 86, which causes the user's profile to be updated with the most current information. The profile then becomes searchable and viewable by other users.

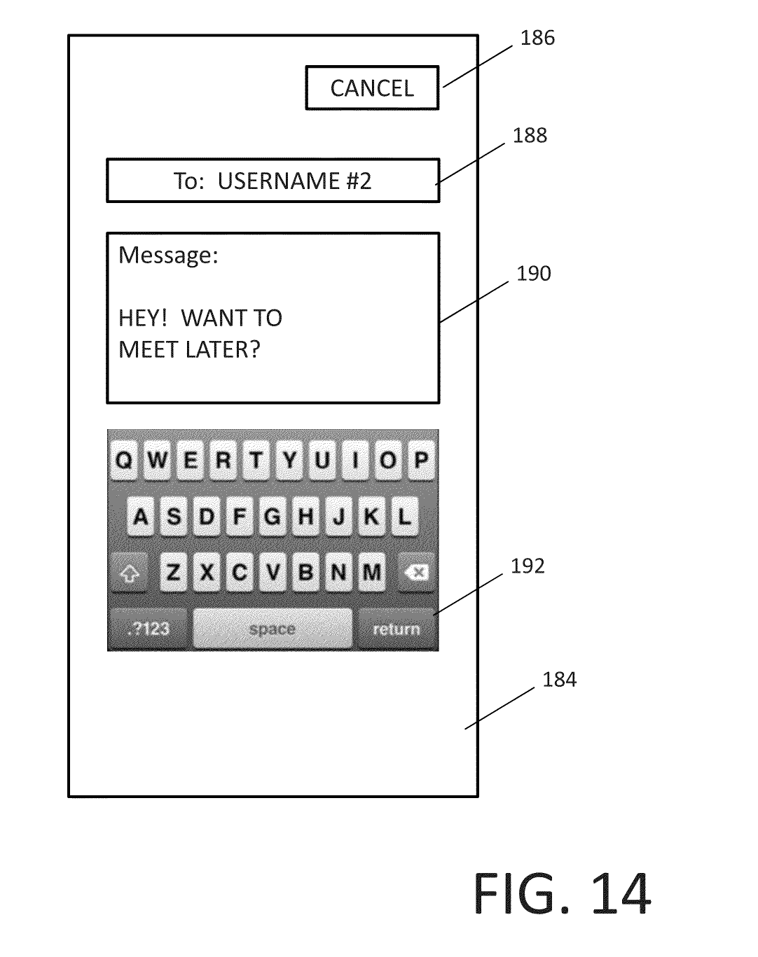

At the top of the initialization interface 70, two additional icons are provided. The mail icon 88 may provide an indication of the status of an electronic mail. For example, the electronic mail icon 88 may indicate the total number of unread e-mail messages that the user has received. The mail icon 88 also is contemplated to provide access to a mail interface 184, such as the example provided in FIG. 14 and described in greater detail below. The initialization interface 70 also includes a “back” icon 90 that permits the user to return to a previously-displayed screen.

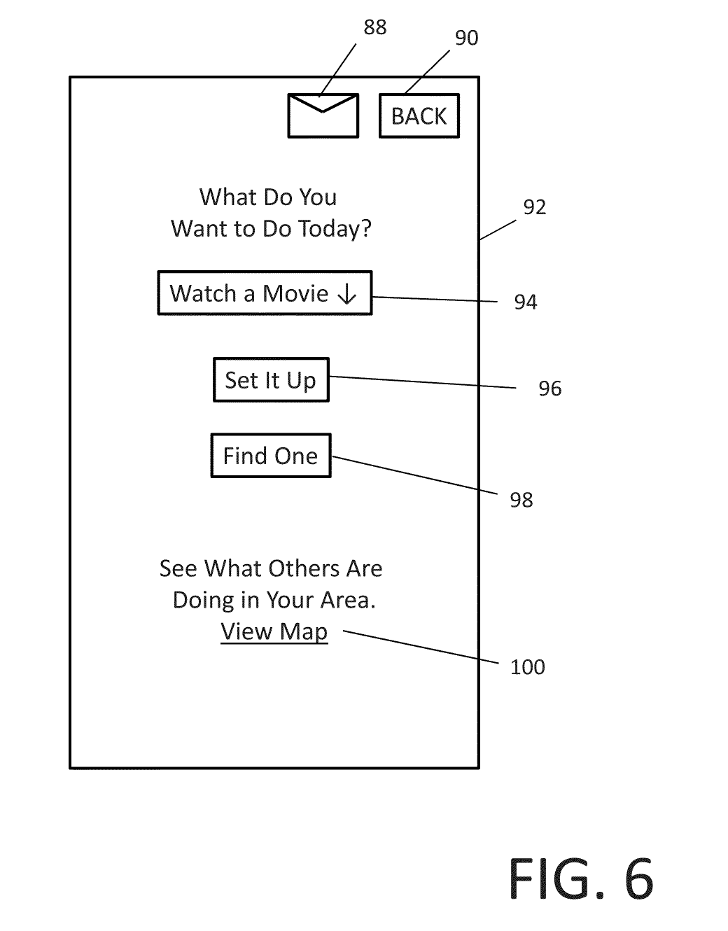

The method 10 proceeds from the initialization step 14 to step 16, where a dashboard interface 92 (see FIG. 6) is displayed to the user. The dashboard interface 92 is contemplated to include one or more input fields so that a user may provide information with respect to specific events. As such, the dashboard interface 92 that is displayed in step 16 is contemplated to be one of the introductory screens that are provided to the user.

As should be apparent, after the initialization step 14, the user will not be prompted normally to enter personal information again, unless or until the user chooses to do so. When the user accesses the method 10 of the present invention after initialization (i.e., a subsequent access), it is contemplated that the method 10 of the present invention will direct the user to step 16, where the dashboard interface 92 is displayed.

FIG. 6 provides one contemplated GUI for the dashboard interface 92 that is contemplated to be made available at step 16. The GUI illustrated in FIG. 6 is labeled 92 and is the dashboard interface 92 to which reference is made herein. As is apparent from the GUI for the dashboard interface 92, the user may access an event category selector icon 94. Access of the event category selector icon 94 is contemplated to reveal a drop down menu with multiple, selectable options. For example, the user may select one from a predetermined number of categories including, but not limited to, “watch a movie,” “attend a show,” “get a drink,” “grab a meal,” “get coffee,” etc. By selecting a category from the event category selector icon 94, the user is prompted to provide input so that the user may refine a search to include one or more selected categories of events. The event category selector icon 94 is contemplated to reveal a drop down menu that is customizable by the user. Alternatively, the event category selector icon 94 may present a predefined list of options that are not customizable by the user.

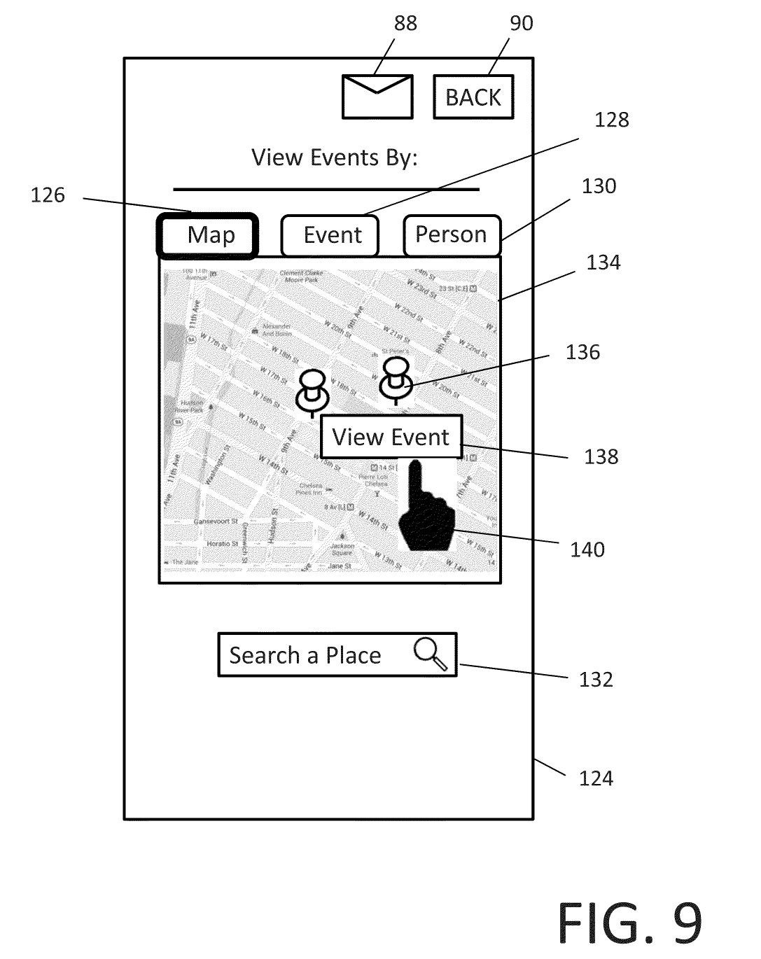

As also depicted in FIG. 6, the dashboard 92 includes a “Set It Up” icon 96, for which input is received in step 18. As also is apparent from the dashboard interface 92, the user may select the “Find One” icon 98, for which input is received in step 20. In addition, the dashboard interface 92 includes a map view icon 100, which permits the user to access a map on which one or more events are displayed. The map view icon 100 is contemplated to access the map interface, one contemplated embodiment of which is illustrated in FIG. 9.

From step 16, the method 10 of the present invention proceeds to either one of step 18, where the method 10 receives input from the user selecting access to a menu to establish a new event. Alternatively, the method 10 may direct the user to step 20 where the method 10 receives input from the user selecting access to a menu to find an established event. For reference, a new event is one that is not yet accessible through step 20. An established event is one that is accessible through step 18.

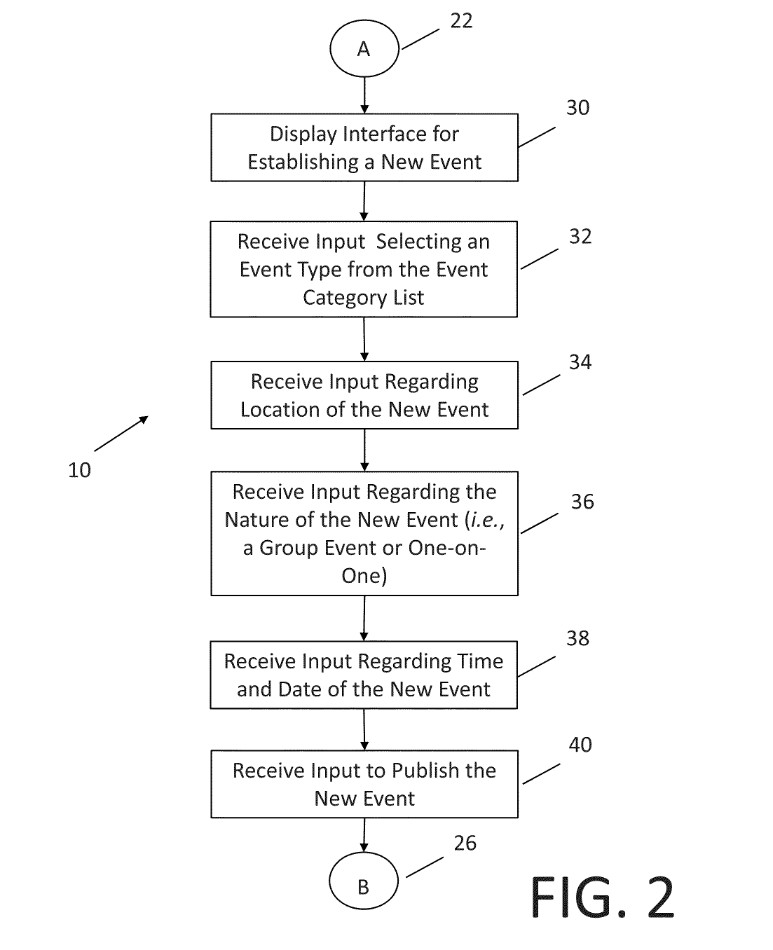

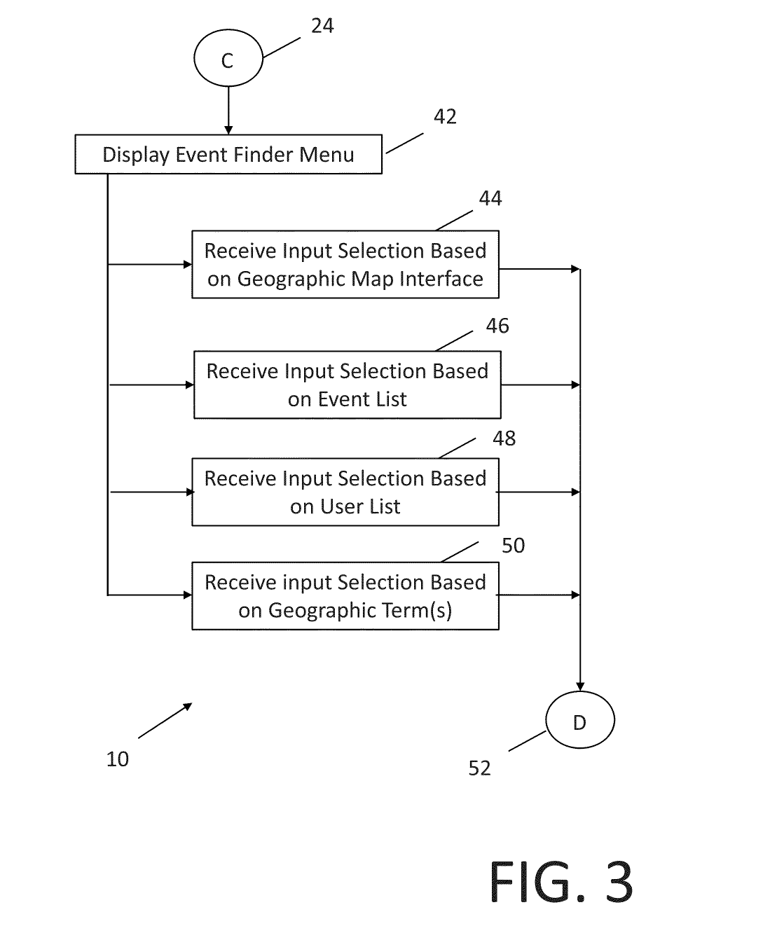

If the method 10 proceeds to step 18, the method 10 receives input selecting access to a menu to establish a new event via the “Set It Up” icon 96. As indicated in FIG. 1, the method transitions to FIG. 2, through the connector “A” 22. If the method 10 proceeds to step 20, the method 10 receives input selecting access to a menu to find an established event via the “Find One” icon 98. As indicated in FIG. 1, the method 10 transitions to FIG. 3 from the connector “C” 24.

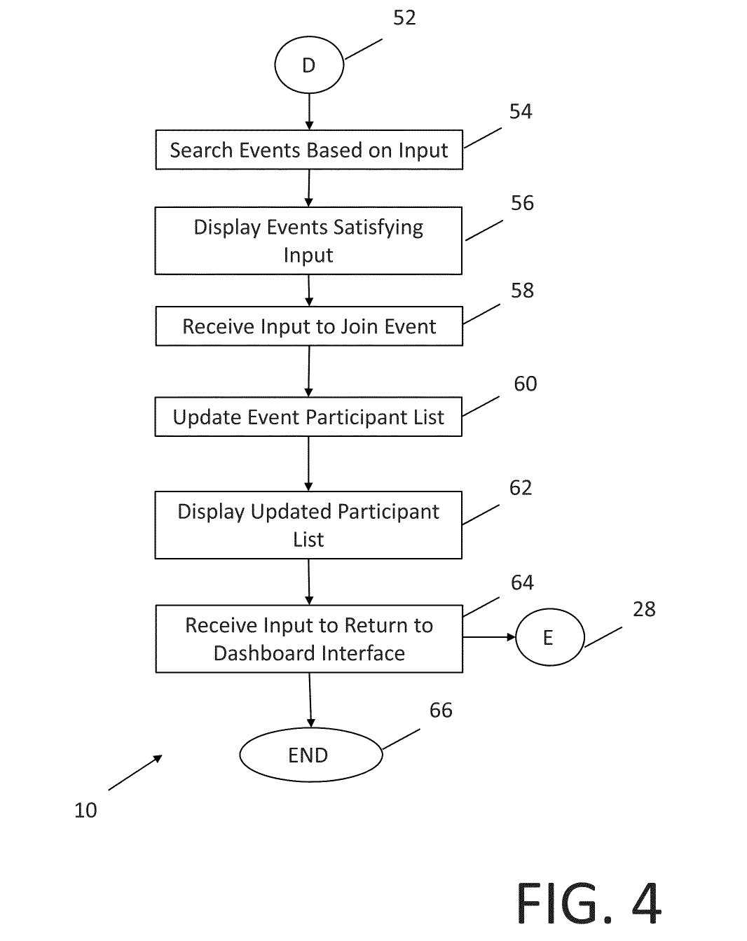

With continued reference to FIG. 1, the connector “B” 26 is accessed after the conclusion of the steps detailed in FIG. 2. The connector “E” 28 is accessed after the steps detailed in FIG. 4. Details of these connections are provided in the paragraphs that follow.

If the method 10 receives input selecting access to the menu to establish a new event at step 18, the method 10 proceeds to step 30, which is detailed in FIG. 2. As should be apparent, the user is understood to provide the input for step 18. It is noted that the method 10 may receive and process information that is not provided directly by the user. For example, the method 10 may process GPS data, which is automatically generated by the user's electronic device or platform on which the method 10 is executed.

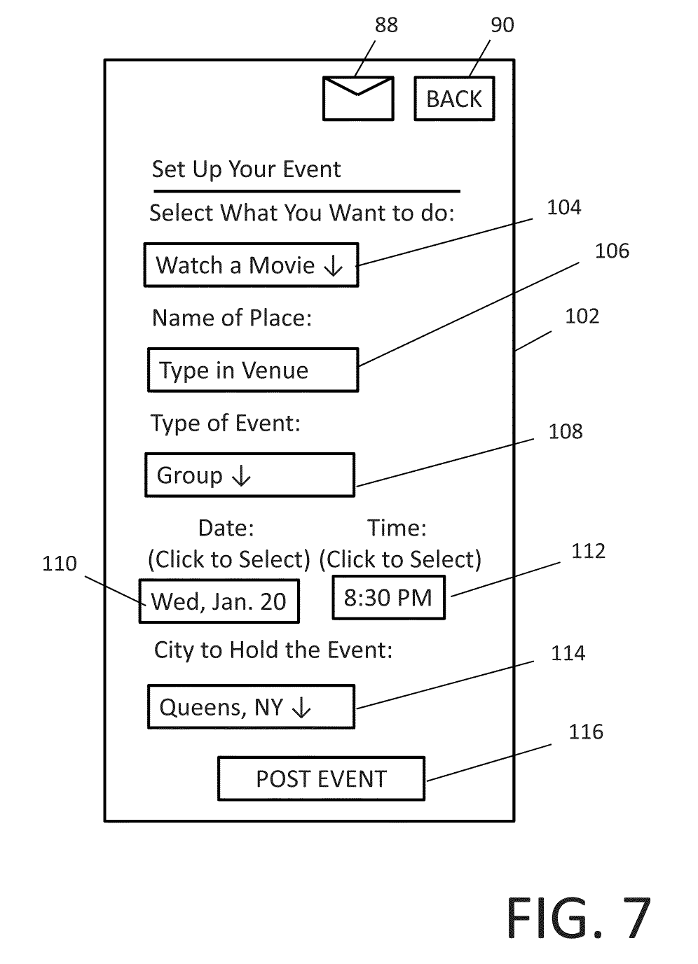

At step 30, the method 10 displays a menu, which is a GUI for establishing a new event. One contemplated menu, referred to as the new event interface 102, is shown in FIG. 7.

With reference to the method 10 that is illustrated in FIG. 2, the new event interface 102 is displayed at step 30. As should be apparent, the new event interface 102 is merely one example of a menu that may be displayed to the user as a result of the operation of the method 10 of the present invention. The menu (along with the other GUIs that are illustrated herein) is meant to be illustrative of the present invention and not limiting thereof.

The method then proceeds to step 32 where the method 10 receives input selecting an event type from the event category list icon 104. As should be apparent, the user optionally selects the event category including, but not limited to, “watch a movie,” “attend a show,” “get a drink,” “grab a meal,” “get coffee,” etc. The event category list icon 104 is contemplated to encompass the same events categories as the event category selector icon 94.

As illustrated in FIG. 7, and as identified by step 34 in FIG. 2, the user may input the name of a place (or venue) where the event from the event category list icon 104 is to occur. At the venue block 106, the user may input the name of a particular movie theater (for example, where the user selects “watch a movie” as one of the things that he or she would like to do). A business name or street address may be provided at the venue block 106, among other types of identifying information. As a result, the venue block 106 is contemplated to receive textual input for identification of a particular venue that the method 10 takes into account when limiting the scope of the user's search.

The method 10 then proceeds to step 36 where the method 10 receives input selecting an event type from the event type list icon 108. The input is contemplated to be received from the user. For example, the user may select to setup an event where a “group” of people are invited to watch a movie at a selected movie theater. Alternatively, the type may be “one-on-one.” While it is contemplated that the method 10 will receive input selecting an event type in step 36, this step is considered optional. The method 10 does not require input of an event type in step 36 for its operation.

Following step 36, the method 10 proceeds to step 38 where input is received regarding the date and time for the new event. The date is provided via a date block 110. The time is inputted via a time block 112. The date and time blocks 110, 112 are illustrated in FIG. 7. The date and time information may be inputted as textual data into the date and time blocks 110, 112.

Separately, a geographic location icon 114 is provided in the new event interface 102. The geographic location list icon 114, which is optional, may receive typewritten data. Alternatively, the geographic location list icon 114 may rely upon a drop down menu that is customized for the user based on the user's actual, geographic location.

After the user has inputted and/or selected relevant data, the user may post the new event by accessing the “post event” icon 116. By so doing, the user provides input to the method 10 to publish the new event, as indicated by step 40 in FIG. 2.

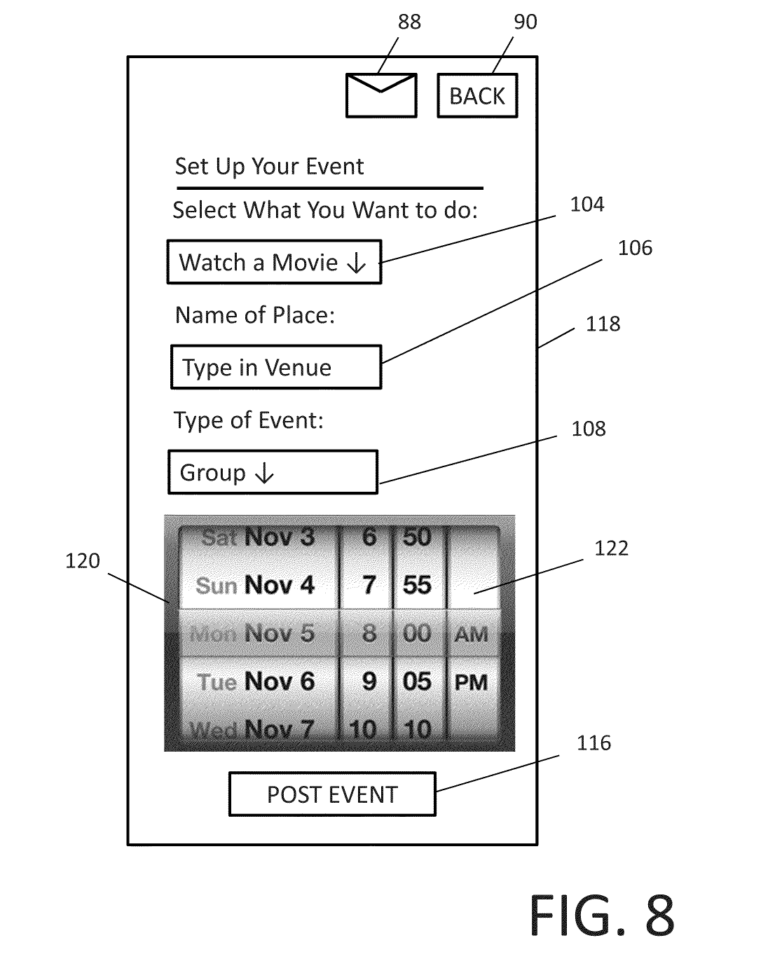

FIG. 8 illustrates a variation on the new event interface 102. In FIG. 8, the new event interface 118 includes a date icon 120 and a time icon 122 that are displayed as wheels. As should be apparent to those skilled in the art, the wheels are contemplated to be moved, by a swiping motion from the user, until the date and time icons 120, 122 display the correct information.

As noted above, after the date and time information are inputted at step 38, the method 10 proceeds to step 40. At step 40, the method 10 receives input to publish the event. The action to publish the event may be by a publication icon 116, which is provided in the new event interface 102, 118.

After the method is published, participants may sign up for the event or otherwise indicate that they plan to attend, as discussed in greater detail below.

After step 40, the method 10 proceeds to the connector “B” 26, which also is indicated on FIG. 1. Once an event is established, the method 10 permits other users to search for the established event.

As discussed above, at step 20, the method 10 receives input selecting access to a menu to find an established event. The method 10 proceeds, via the connector “C” 24 to the steps illustrated in FIG. 3.

At step 42, the method 10 displays the event finder interface, an example of which is depicted in FIG. 9.

The event finder map interface 124 permits searching via one of four contemplated methods. At step 44, the method 10 may receive an input selection based on a geographic map interface 134. The geographic map interface 134 may be accessed via a map icon 126. Alternatively, at step 46, the method may receive an input selection based on access via an event list icon 128. Further, at step 48, the method 10 may receive an input based on a user (or person). A user icon is indicated by reference number 130 in FIG. 9. Finally, at step 50, the method 10 may receive an input based on inputted geographic terms. A geographic term block 132 also is designated in FIG. 9.

Step 44 permits input of information to the method 10 of the present invention by user interaction with a displayed map interface 134. By selecting a pinpoint icon 136, the user may access a view event icon 138, using a suitable pointer 140. After accessing the pinpoint icon 136, the user may access detailed information concerning the event associated with pinpoint icon 136.

It is contemplated that the method 10 of the present invention will rely on Global Positioning System (“GPS”) data that is provided by the user's interface device. With the GPS data, the method 10 selects an appropriate geographical context for display, typically one local to the user's interface device (e.g., a mobile phone, tablet, or other electronic device). If the user's interface device does not provide GPS data to the method 10 of the present invention, the user may be prompted to enter location information so that a suitable geographic region may be displayed to the user.

It is contemplated that the method 10 of the present invention will indicate local, established events via virtual pins 136 that are provided on the map interface 134 displayed in the event finder map interface 124. The user may then access the details of individual events by touching the pins 136 on the map interface 134, as indicated above.

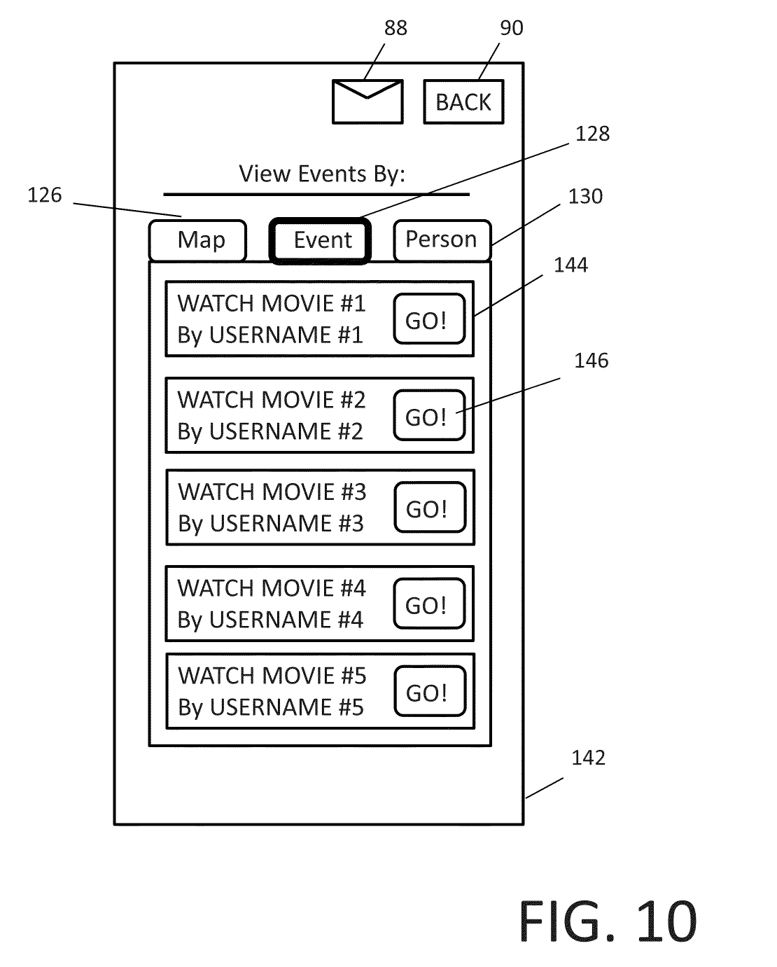

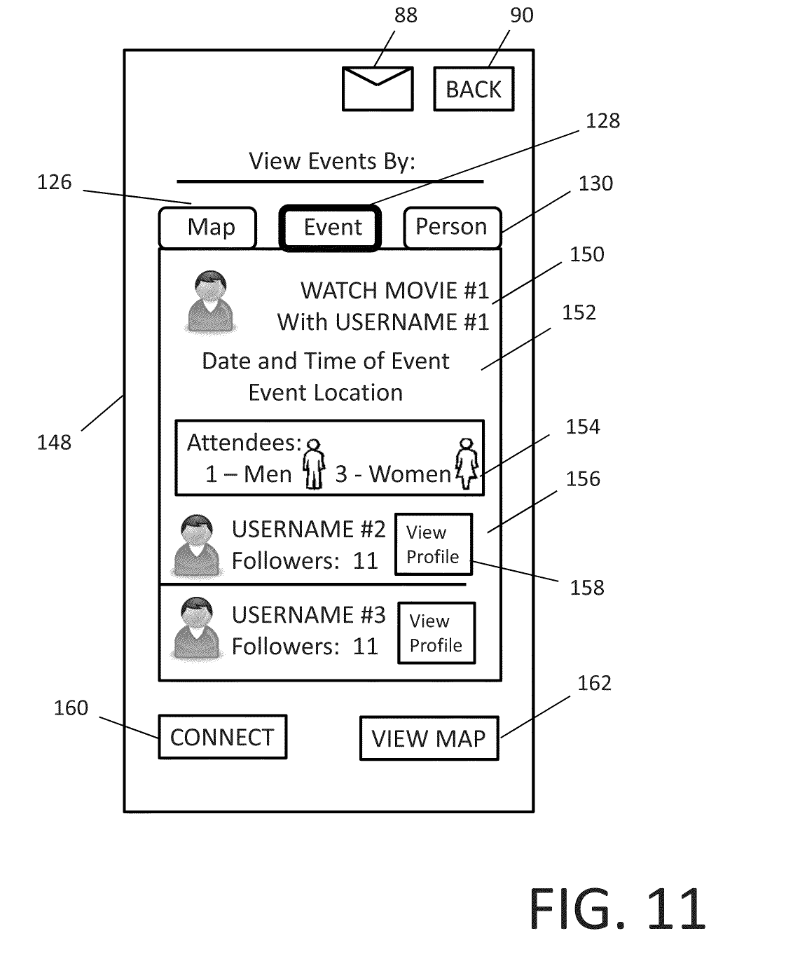

In step 46, as illustrated in FIGS. 10 and 11, the method 10 of the present invention may provide the user with a list of events in the local area. Events are accessible via the events icon 126.

After selecting one of the events listed in FIG. 10 on the event list interface 142, the user may be provided with details about that individual event as well as other events that are hosted by the same individual or other individuals. This is indicated in FIG. 11.

FIG. 10 provides one contemplated embodiment of the event list interface 142 that includes a listing of multiple events 144. The “Go!” icon 146 associated with the individual events 144, when selected, permits the user to access information about the individual event 144.

FIG. 11 provides an embodiment of a single event interface 148 contemplated as a part of the present invention. It is contemplated that the single event interface 148 will be presented to the user after selecting the “Go!” icon 146 illustrated in FIG. 10. The single event interface 148 is contemplated to provide information such as basic information about the sponsor of the event and the event type 150. The date and time 152 of the event also is provided, together with a summary of the attendees 154. Individual event entries 156 for the attendees are provided for additional detail concerning the attendees. In connection with each individual event entry 156, the user may select the view profile icon 158 to discover additional information about the attendees. In addition, the user may access a connect icon 160 to connect to one of the attendees. Finally, a view map icon 162 may be accessed so that the user may locate the event geographically.

At step 48, the user may access and provide input for events that are hosted by a particular individual. In other words, the method 10 of the present invention provides a display to the user that lists all of the events hosted by another user. Individual events may then be selected for participation (i.e., the user may “join” the event(s)).

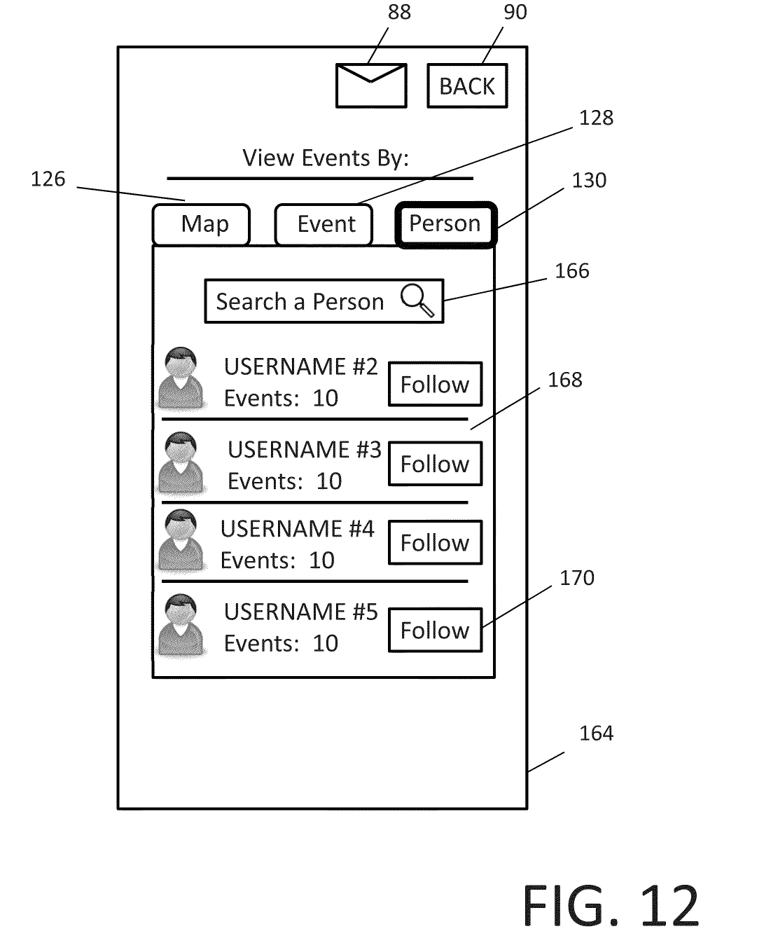

A person interface 164, which includes details for one such contemplated interface, is provided in FIG. 12. The person interface includes a person lookup block 166, which permits the user to search for another user and the events that are associated with that other user. The person interface 164, therefore, includes a list of individuals 168, each of which has a follow icon 170 associated with him or her. Once the user identifies one of the other users from the individuals list 168, the user may select the follow icon 170 to locate the events that an individual is attending.

At step 50, the user may be prompted to provide information to find events in a particular geographic location. For example, the method 10 of the present invention may receive input that the user would like to know about events in a location remote from the user (or at the same geographic location as the user).

As should be apparent, steps 44, 46, 48, 50 are considered to operate independently from one another and provide a separate avenue for access to event information made available through the method 10 of the present invention.

After receiving specific input via one of the steps 44, 46, 48, 50, the method 10 proceeds to step 54 via the connector “D” 52.

At step 54, the method 10 searches events within a database based on the input received by the method 10 from the user. At step 56, the method 10 displays events that satisfy the inputted search parameters. At step 58, the method 10 receives input indicating that the user wishes to join a particular event. At step 60, the method 10 updates the participant list to add those who have indicated interest in joining the event. At step 62, the method 10 displays the updated list of participants. At step 64, the method receives input to return to the dashboard, whereupon the method returns to step 16 via the connector E 28. If the method 10 does not receive input to return to the dashboard, the method ends at step 66.

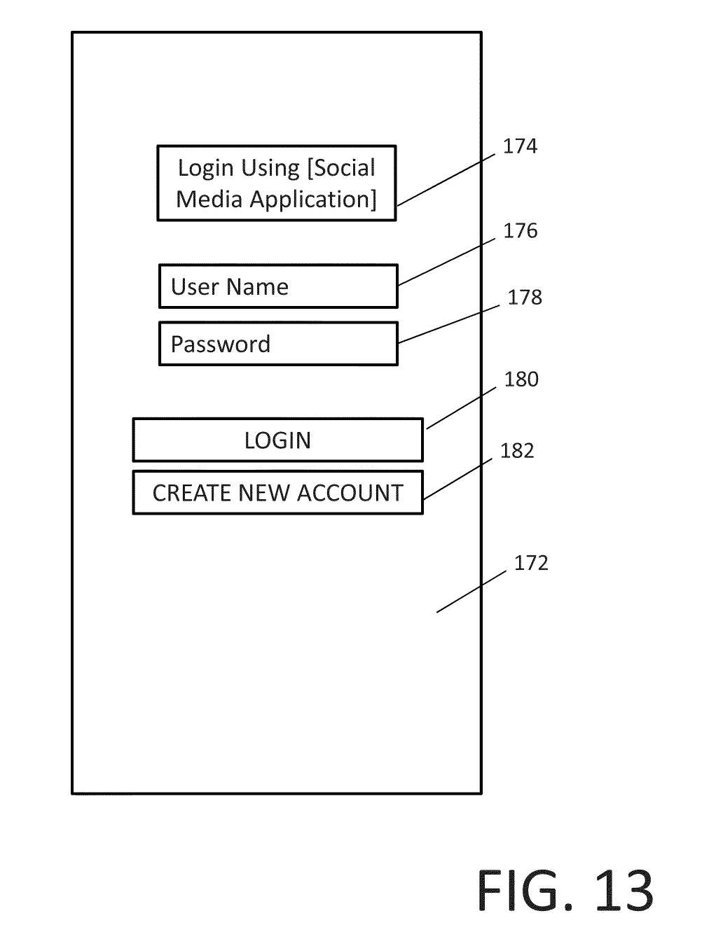

FIG. 13 provides an alternative contemplated embodiment of a dashboard interface 172 that may be presented to new and existing users. The dashboard interface 172 includes a social media login icon 174 to facilitate rapid login. The dashboard interface 172 also includes a user name block 176 and a password block 178 into which the use may enter login information to access the method 10. The login icon 180 is contemplated to be accessed after the blocks 176, 178 are completed. The “create new account” icon 182 permits a new user to create a new profile, as discussed above.

FIG. 14 is an embodiment of a contemplated message interface 184 that is contemplated to be accessible via the method 10 of the present invention. Specifically, the message interface 184 may be accessible from any one of the interfaces discussed above via a suitable icon. The message interface 184 includes a cancel icon 186, should the user decide not to send a message. The message interface 184 includes a recipient block 188 into which a recipient's username (or other suitable identifier) may be entered so that any messages are appropriately routed. The message interface 184 also includes a message block 190 into which text may be entered. A keyboard 192 if illustrated for entry of the content of the message.

In the method 10, the message interface 184 is not illustrated as a step. It is contemplated that the message interface 184 will be made available from various ones of the interfaces discussed above, via the message icon 88. As such, the algorithm for messaging is considered to run in parallel with the method 10 described herein.

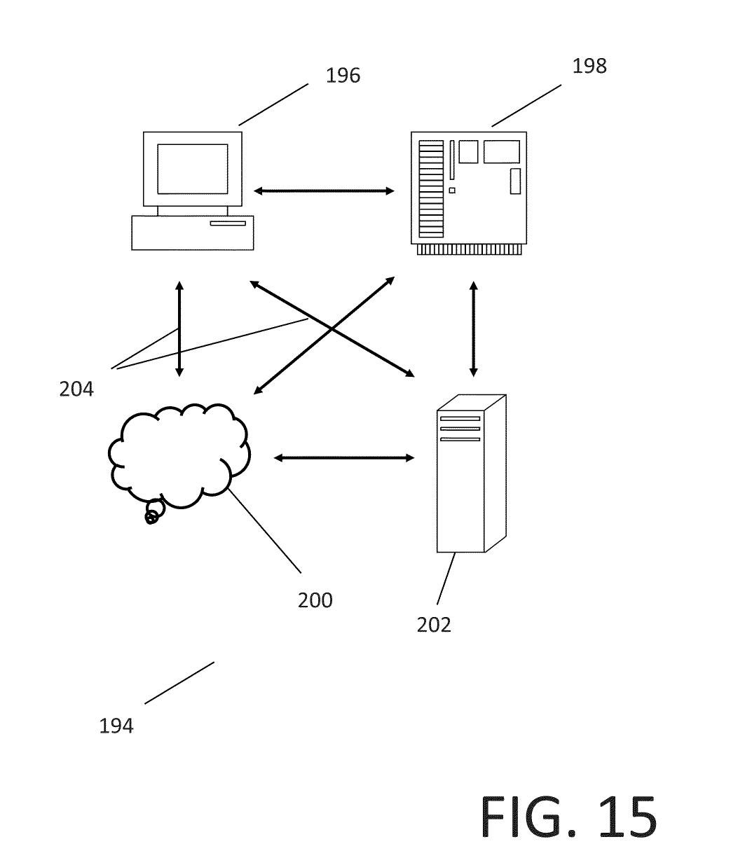

FIG. 15 provides a graphical overview of one architecture contemplated for the system on which the method of the present invention is contemplated to operate. The system 194 includes a mobile device 196 that is connected to a server 198, the Internet 200 (or other suitable wide area network, local area network, etc.) and a database 202. The mobile device 196, the server 198, the Internet 200, and the database 202 are contemplated to connect via wireless communication lines 204. Any one component may communicate with any other component, either directly or indirectly (via another component). The communication lines 204 may be wired without departing from the scope of the present invention.

The method 10 is contemplated to be resident on a mobile computing device 196, such as a smartphone or tablet. The method 10 is contemplated to receive input (as noted above) and store information on a database 204, which may be part of the computing device 196 or located remotely from the computing device 196. At a minimum, the method 10 is contemplated to interface with the database 202 and one or more servers 198 so that the method 10 may assess the geographic location of the user and one or more established events that are available to the user within the geographic location. While the method 10 is contemplated to be executed on the computing device 196, any portion of the method may be executed on any other component of the system 194, in whole or in part, without departing from the scope of the present invention.

The computing device 196 is contemplated to include a display and a processor. The display is contemplated to be touch-sensitive. As a result, the user may interact with the display to provide input for the method 10. In addition, the display provides output to the user.

With the foregoing in mind, it is noted that the present invention may be summarized at least as set forth below.

The method 10 is contemplated to be provided for social networking focusing on events. The method 10 is executable via a device 196 that includes a processor and a display. The method 10 includes, via the device 196, receiving input selecting access to a first interface, such the dashboard interface 92, to search for an established event 144 from a plurality of established events and receiving at least one input parameter for searching for the established event 144. The method 10 further includes searching through the plurality of established events 144 based on the at least one input parameter and, via the display, displaying established events 144 results including those established events satisfying the at least one search parameter. In addition, the method 10 includes, via the device 196, receiving input to join at least one event from the established events results, creating a joined event.

In one contemplated embodiment, it the method 10 may update a list of participants for the joined event to create an updated list of participants.

In another contemplated embodiment, the updated list of participants for the joined event may be provided to the user via the display.

It is contemplated that the method 10 will include, via the device 196, receiving input to request return to the dashboard interface 92. This permits the user to begin a new search, for example.

In the method 10 contemplated for the present invention, the input parameters may include variables, such as, a genre of the established event (e.g., event category list icon 104), a name of a venue for the established event (e.g., venue block 106), a date for the established event (e.g., date block 110 or date icon 120), a time for the established event (e.g., time block 112 or time icon 122), and a type of the established event indicating a number of persons involved therein (e.g., event type list icon 108).

The method 10 also may include, before the step of receiving input parameters for searching for established events, receiving an input selection based on a geographic map interface (e.g., event finder map interface 124) via the device 196.

Alternatively, the method 10 may include, before the step of receiving input parameters for searching for established events 144, receiving an input selection based on an event list interface (e.g., event list interface 142). This input selection is contemplated to be received through the device 196.

Also, before the step of receiving input parameters for searching for established events, it is contemplated that the device 196 may receive an input selection based on a person interface (e.g., the person interface 164).

The method 10 of the present invention also may include, via the device 196, receiving input selecting access to a second interface (e.g., new event interface 118) to establish a new event. If so, it is contemplated that the device 196 may receive input regarding the genre of the new event (e.g., via the event category list icon 104), which may be selected from a list of genres for the new event, regarding a name of a venue for the new event (e.g., via the venue block 106), or regarding a time and date of the new event (e.g., via the date block 110 (or the date icon 120) and the time block 112 (or the time icon 122)).

Via the device 196, it is contemplated that the method 10 will receive input to publish the new event as the established event 144.

It is also contemplated that the method 10 may receive input regarding the number of participants for the new event. If so, the method 10 is contemplated to update a list of participants for an established event 144 and, via the display 196, display the updated list of participants for the established event 144.

After creating and publishing the new event, the method 10 includes receiving input to request return to the first interface or the second interface.

The device 196 may include a touch-sensitive display interface. Moreover, the device may be configured to display an alphanumeric keyboard.

The device 196 may be a smartphone, tablet, or mobile computer.

As noted above, the present invention is described in connection with one or more embodiments thereof. The embodiments are intended to be illustrative of the breadth of the present invention. Focus on any one particular embodiment is not intended to be limiting thereof. The present invention, therefore, is intended to encompass variations and equivalents, as would be appreciated by those skilled in the art.

What is claimed is:

1. A method for social networking focusing on events, executable via a device including a processor and a display, comprising:
via the device, receiving input selecting access to a first interface to search for an established event from a plurality of established events;
via the device, receiving at least one input parameter for searching for the established event;
searching through the plurality of established events based on the at least one input parameter;
via the display, displaying established events results including those established events satisfying the at least one search parameter; and
via the device, receiving input to join at least one event from the established events results, creating a joined event.

2. The method of claim 1, further comprising:
updating a list of participants for the joined event to create an updated list of participants.

3. The method of claim 2, further comprising:
via the display, displaying the updated list of participants for the joined event.

4. The method of claim 3, further comprising:
via the device, receiving input to request return to the first interface.

5. The method of claim 1, wherein the input parameters include at least one of a genre of the established event, a name of a venue for the established event, a date for the established event, a time for the established event, and a type of the established event indicating a number of persons involved therein.

6. The method of claim 1, wherein the step of receiving input parameters for searching for established events is preceded by:
via the device, receiving an input selection based on a geographic map interface.

7. The method of claim 1, wherein the step of receiving input parameters for searching for established events is preceded by:
via the device, receiving an input selection based on an event list interface.

8. The method of claim 1, wherein the step of receiving input parameters for searching for established events is preceded by:
via the device, receiving an input selection based on a person interface.

9. The method of claim 1, further comprising:
via the device, receiving input selecting access to a second interface to establish a new event.

10. The method of claim 9, further comprising:
via the device, receiving input regarding the genre of the new event.

11. The method of claim 10, wherein the input regarding the genre of the new event is selected from a list of genres for the new event.

12. The method of claim 9, further comprising:
via the device, receiving input regarding a name of a venue for the new event.

13. The method of claim 9, further comprising:
via the device, receiving input regarding at least one of a time and date of the new event.

14. The method of claim 9, further comprising:
via the device, receiving input to publish the new event as the established event.

15. The method of claim 9, further comprising:
via the device, receiving input regarding the number of participants for the new event.

16. The method of claim 14, further comprising:
updating a list of participants for an established event; and
via the display, displaying the updated list of participants for the established event.

17. The method of claim 16, further comprising:
via the device, receiving input to request return to at least one of the first interface and the second interface.

18. The method of claim 1, wherein the device includes a touch-sensitive display interface.

19. The method of claim 18, wherein the device is configured to display an alphanumeric keyboard.

20. The method of claim 1, wherein the device is at least one of a smartphone, tablet, or personal computer.
